(19) United States
(12) Patent Application Publication
(10) Pub. No.: US 2011/0078749 A1
(43) Pub. Date: Mar. 31, 2011

(54) EMBEDDED WIRELESS ANTENNA FOR NETWORK TV

(75) Inventor: Christopher P. Wieck, San Diego, CA (US)

(73) Assignees: SONY CORPORATION; SONY ELECTRONICS INC.

(21) Appl. No.: 12/569,197

(22) Filed: Sep. 29, 2009

(51) Int. Cl. H04N 7/18; H04N 5/50; H04N 5/64

(52) U.S. Cl. 725/81; 348/731; 348/836; 348/E05.097; 348/E05.128

(57) ABSTRACT

A WiFi chipset is integrated into a TV chassis as are wireless audio-video signal antennas that feed the chipset and that are embedded in the display bezel. The TV processor causes signals from home network components received through the antennas and chipset to be displayed on the TV.

### I. FIELD OF THE INVENTION

The present invention relates generally to embedded wireless modules (chipsets) and associated antennas for network TVs.

### II. BACKGROUND OF THE INVENTION

Home networks are provided in which information including multimedia is shared among networked components. For example, a TV might access a disk player or central server to play multimedia programming stored on disk or at the server. The TV might also access a hard disk drive to play recorded TV programming, display digital photographs, etc.

TVs also evolve, and presently relatively large flat panel display TVs can be mounted on walls as beautiful pieces of art work in which unsightly wires (network cables, video cables, etc.) are removed from view. This is often accomplished using wireless technology, wherein TVs wirelessly receive multimedia information from other components in the network.

As understood herein, relatively large wireless bandwidth is required to transfer multimedia information in a home network. For instance, compressed high definition (HD) video requires between twenty and fifty megabits per second of bandwidth.

Also understood herein, the evolution of flat panel display TVs has progressed with an emphasis on the TV's aesthetic value as it hangs in a room. With this in mind, TVs have morphed in decoration and become increasingly slim around the border of the display screen, limiting the space in which an antenna to support a WLAN network may be housed. Display screen borders in upcoming models are expected to be decorative, e.g. comprised of a transparent material, such as glass, further restricting the placement area for an antenna to have an unabated view of the room behind the TV.

### SUMMARY OF THE INVENTION

Rather than removing the unsightly antenna, the present invention proposes to disguise the antenna as a cosmetic feature in order to improve antenna performance and maintain a sleek look.

Accordingly, a TV includes a chassis, a TV display on the chassis, and a wireless module supported by the chassis and configured to receive at least audio and video signals. A TV processor communicates with the wireless module. The audio-video signals are presentable on the TV display under the control of the TV processor. A TV tuner receives TV signals from a TV signal source. At least one antenna element is juxtaposed with a bezel surrounding the display, sending at least audio and video signals received from a home network to the wireless module.

Thus, a bezel surrounds the TV display. In example embodiments, various forms of antennas are embedded in the bezel surrounding the display. The bezel may be composed of transparent material, making the antennas themselves cosmetic features particularly when they are evenly placed and of decorative material. The bezel may have additional decorative elements to complement the real antennas.

In some embodiments the antenna element is shaped like an inverted letter “F” defining a stalk of disposed along a diagonal from a corner of the bezel. Or, the antenna element can be a polarization diversity antenna disposed along a diagonal from a corner of the bezel. The antenna element may have a sawtooth shape. Yet again, the antenna element may include a meander line-diversity spacing antenna. Indeed, two meander-line like antenna elements can be parallel to each other and can extend generally vertically from a top edge of the bezel to a top edge of the display.

The antenna element can be molded into a backside of the bezel. Or, the antenna element can be sandwiched between two pieces of the bezel. If desired, a decorative trim line can be disposed along a diagonal from a bezel corner symmetrically with the antenna element.

In another aspect, a display apparatus has a wireless chipset in a display chassis and a video display on the chassis. A bezel borders the display. At least one wireless audio-video signal antenna element feeds data to the chipset. The antenna is disposed on or in the bezel. A processor in the chassis causes signals from components received through the antenna and chipset to be presented on the display.

In another aspect, a system is disclosed for facilitating presentation on a TV in a home network audio-video content wirelessly received from the home network without requiring antenna wires extending outside the TV to receive the content. The system includes means for displaying video content, means for holding the means for displaying. And means for framing the means for displaying. Antenna means are embedded in the means for framing and configured for wirelessly receiving the audio-video content from the home network.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of the front of a wall-mounted flat panel TV, showing network components schematically; and

FIG. 2 is a depiction of a flat panel TV with various antenna embodiments to illustrate potential methods of disguising antenna in display border.

### DETAILED DESCRIPTION OF THE PREFERRED EMBODIMENT

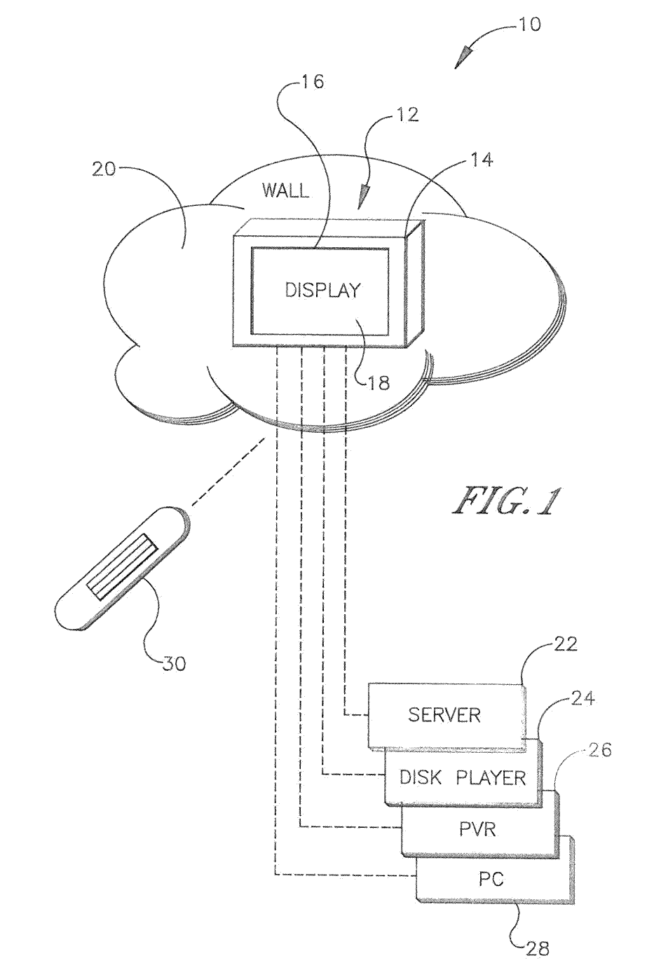

Referring initially to FIG. 1, a home network 10 may include one more TVs 12 (only a single TV shown) with a TV chassis 14 holding a TV display 16. Typically, a plastic frame-like bezel 18 frames the display 16.

A TV 12 may be mounted by means known in the art on a surface 20 of a dwelling, such as a wall or ceiling. The TV 12 may be an analog and/or digital TV with a flat panel (matrix-type) standard definition and/or high definition (HD) display 16, although other types of displays may be used.

The network 10 may include various components that communicate audio-video information wirelessly to the TV 12 using, e.g., WiFi principles, Bluetooth principles, or other wireless principles known in the art. For example, the TV 12 may receive compressed or uncompressed HD video from a computer server 22, a disk player 24, a personal video recorder (PVR) 26, and a personal computer (PC) 28, as well as other information such as digital photographs for display on the TV 12. Other network components such as game players or indeed other TVs may be provided in the network 10. A hand-held remote control device 30 may be manipulated by a person to input wireless command signals to the TV 12 and/or to various network components in accordance with principles known in the art.

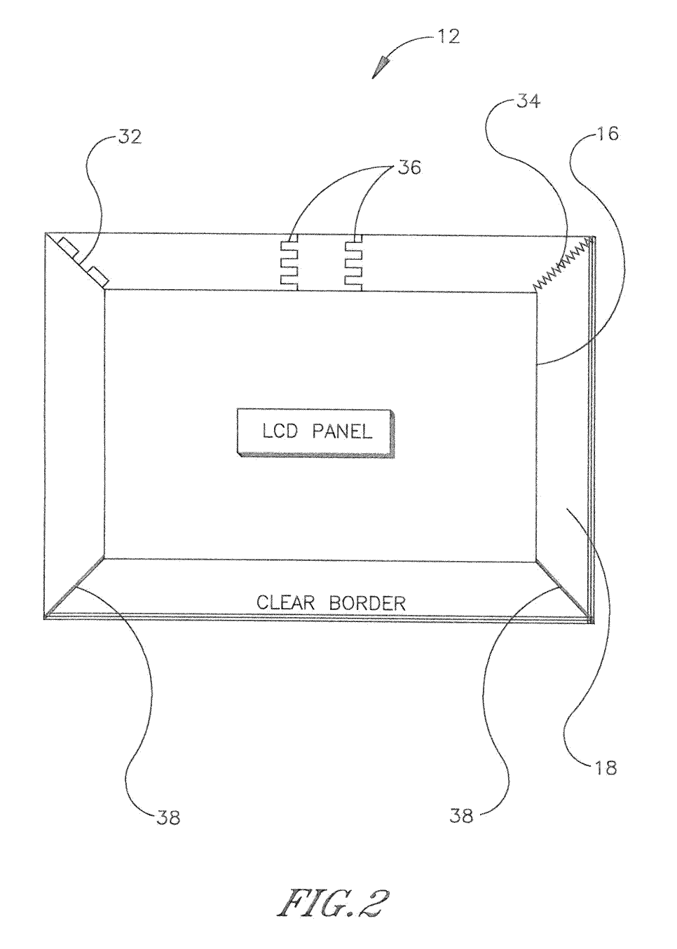

Now referring to FIG. 2, the front of the TV 12 is shown. The display 16, such as a liquid crystal display (LCD), is framed by a bezel 18, illustrated here to be comprised of a clear or translucent material, e.g. glass. The bezel 18 may be any decorative item however, such as clear or translucent plastic. Example embodiments of the decorative antenna in the top left and top right corners of the bezel 18, inverted—F antenna 32 (i.e., an antenna shaped like an inverted letter “F”, in some embodiments with the two cross lines connected together as shown and the stalk of the “F” disposed along a diagonal from the top left corner) and diagonal polarization diversity antenna 34, respectively, which may be 2×MIMO antennas with polirization diversity. The diagonal antenna 34 is disposed along a diagonal from a corner such as the top right corner of the bezel as shown, and may have a sawtooth shape as shown. Alternatively, both antennas may be embedded in each corner for 4×4 802.11n MIMO, or any combination thereof.

The third example embodiment, a meander line-diversity spacing antenna 36, can be spaced around the bezel 18 for diversity performance. As shown, the antenna 36 may include two meander-line like elements parallel to each other and extending generally vertically from the top edge of the bezel 18 to the top edge of the display 16.

Any one or combination of the embodiments may be overmolded into the bezel (border) 18, although the preferred mounting method is molded into the backside of the bezel 18 or sandwiched between two pieces of the bezel 18 to avoid damage. Regardless, the antennas preferably are embedded in the bezel to present a flush surface. The three embodiments shown in this figure may or may not be all used together. They are simply shown together in FIG. 2 to conveniently illustrate various antenna structures that allow for cosmetic viewing pleasure. It is desirable that the antennas are disposed away from the metal display shield for improved reception.

If desired, decorative trim lines 38 may be embedded or deposited or otherwise disposed on the bottom right and bottom left corners as shown, symmetrically to match the real antenna elements on the upper corners. The trim 38 may be of any decorative material, e.g., gold wire or bordering.

While the particular EMBEDDED WIRELESS ANTENNA FOR NETWORK TV is herein shown and described in detail, it is to be understood that the subject matter which is encompassed by the present invention is limited only by the claims.

What is claimed is:

1. TV comprising:
a chassis;
a TV display on the chassis;
a wireless module supported by the chassis and configured to receive at least audio and video signals;
a TV processor communicating with the wireless module, the audio-video signals being presentable on the TV display under the control of the TV processor;
a TV tuner receiving TV signals from a TV signal source; and
at least one antenna element juxtaposed with a bezel surrounding the display and sending at least audio and video signals received from a home network to the wireless module.

2. The TV of claim 1, wherein the antenna element is shaped like an inverted letter “F” defining a stalk of disposed along a diagonal from a corner of the bezel.

3. The TV of claim 1, wherein the antenna element is a polarization diversity antenna disposed along a diagonal from a corner of the bezel.

4. The TV of claim 3, wherein the antenna element has a sawtooth shape.

5. The TV of claim 1, wherein the antenna element includes a meander line-diversity spacing antenna.

6. The TV of claim 5, comprising two meander-line like antenna elements parallel to each other and extending generally vertically from a top edge of the bezel to a top edge of the display.

7. The TV of claim 1, wherein the antenna element is molded into a backside of the bezel.

8. The TV of claim 1, wherein the antenna element is sandwiched between two pieces of the bezel.

9. The TV of claim 1, comprising at least one decorative trim line disposed along a diagonal from a bezel corner symmetrically with the antenna element.

10. Display apparatus, comprising:
wireless chipset in a display chassis;
video display on the chassis;
bezel bordering the display;
at least one wireless audio-video signal antenna element feeding data to the chipset, the antenna being disposed on or in the bezel; and
processor in the chassis causing signals from a component received through the antenna and chipset to be presented on the display.

11. The apparatus of claim 10, wherein the antenna element is shaped like an inverted letter “F” defining a stalk of disposed along a diagonal from a corner of the bezel.

12. The apparatus of claim 10, wherein the antenna element is a polarization diversity antenna disposed along a diagonal from a corner of the bezel.

13. The apparatus of claim 12, wherein the antenna element has a sawtooth shape.

14. The apparatus of claim 10, wherein the antenna element includes a meander line-diversity spacing antenna.

15. The apparatus of claim 14, comprising two meander-line like antenna elements parallel to each other and extending generally vertically from a top edge of the bezel to a top edge of the display.

16. The apparatus of claim 10, wherein the antenna element is molded into a backside of the bezel or sandwiched between two pieces of the bezel.

17. The apparatus of claim 10, comprising at least one decorative trim line disposed along a diagonal from a bezel corner symmetrically with the antenna element.

18. System for facilitating presentation on a TV in a home network audio-video content wirelessly received from the home network without requiring antenna wires extending outside the TV to receive the content, comprising:
means for displaying video content;
means for holding the means for displaying;
means for framing the means for displaying; and
antenna means embedded in the means for framing and configured for wirelessly receiving the audio-video content from the home network.

19. The system of claim 18, wherein the means for framing is a bezel and the antenna means includes at least one antenna element selected from the group of: an inverted letter “F” defining a stalk of disposed along a diagonal from a corner of the bezel, a polarization diversity antenna disposed along a diagonal from a corner of the bezel, a meander line-diversity spacing antenna.

20. The system of claim 19, comprising at least one decorative trim line disposed along a diagonal from a bezel corner symmetrically with the antenna element.
